(19) United States
(12) Patent Application Publication
(10) Pub. No.: US 2009/0010336 A1
(43) Pub. Date: Jan. 8, 2009

(54) MOTION ESTIMATION OPTIMIZATIONS FOR AUDIO/VIDEO COMPRESSION PROCESSES

(75) Inventors: Oscar Chi Lim Au, Kowloon (HK); Jody Chi Wang Ho, Tai Po (HK)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Kowloon (HK)

(21) Appl. No.: 11/774,044

(22) Filed: Jul. 6, 2007

(51) Int. Cl. H04N 7/26

(52) U.S. Cl. 375/240.16; 375/E07.104

(57) ABSTRACT

Motion estimation (ME) optimizations are provided for video encoding and compression processes that efficiently share data processing between host and graphics processing models. The optimizations take into account block level dependencies introduced by a corresponding encoding model, such as dependencies introduced by H.264/AVC among adjacent blocks. Arithmetic intensity of the graphics processing is adjustable to the underlying graphics hardware for further optimization, resulting in improved, real-time encoding of video data.

### TECHNICAL FIELD

The subject disclosure relates to motion estimation (ME) optimizations for video encoding processes that efficiently processes video data according to a shared co-processing model.

### BACKGROUND

H.264 is a commonly used and widely adopted international video coding or compression standard, also known as Advanced Video Coding (AVC) or Moving Pictures Experts Group (MPEG)-4, Part 10. H.264/AVC significantly improves compression efficiency compared to previous standards, such as H.263+ and MPEG-4. To achieve such a high coding efficiency, H.264 is equipped with a set of tools that enhance prediction of content at the cost of additional computational complexity. Among other features, these tools include variable block-size motion compensation (MC) and quarter-pixel accuracy MC. It has thus been desirable to reduce the complexity associated with performing in the presence of such tools.

For instance, Single Instruction Multiple Data (SIMD) extensions were developed for a central processing unit (CPU) to enhance the performance in multimedia applications dramatically. However, for high-definition video encoding, processing in real-time with a general purpose CPU is still difficult even with highly optimized code. Thus, further optimizations are desired that take advantage of the growing power and speed of the graphics processing unit (GPU) in computing systems to perform fast computations.

In this regard, consumer graphics hardware has become increasingly faster, more flexible and more powerful. Modern graphics hardware includes powerful GPU, which is a stream processor that specialized for processing graphics operations in parallel. In term of raw computational power, today's graphics hardware already surpasses the speed of a CPU by far, and GPU speed continues to grow faster than CPU speed. Furthermore, with respect to flexibility, some stages of the traditional fixed-function graphics pipeline have been replaced by fully programmable modules in modern GPUs. With increasing programmability, the GPU is thus a strong candidate for performing computationally intensive operations alongside many general-purpose applications.

While, at a high level, GPU-based modules have been provided to aid in image and video decoding, no existing systems have implemented encoder acceleration efficiently using a GPU. For instance, one system generally proposes using a GPU to perform motion estimation (ME), which is the most computational intensive component of the video encoder, by calculating an absolute difference at the frame-level. However, such systems are not designed for encoding-specific dependencies that can exist, making such implementations sub-optimal under circumstances involving such encoding-specific dependencies.

Furthermore, existing systems have been observed to suffer from unsatisfactory performance because of their relatively low arithmetic intensity, which is defined as operation per word transferred. In other words, existing systems that have used a GPU-based module are relatively inefficient in terms of re-use of loaded data while accessible to the GPU.

Accordingly, it would be desirable to provide more optimal co-processing solutions, e.g., a host processor and a co-processor such as a CPU sharing processing with a GPU, for performing media encoding or compression. It would be further desirable to optimize ME in the presence of dependencies introduces by an encoding format, such as for block level dependencies introduced by H.264.

The above-described deficiencies of current designs for GPU-assisted encoding or compression are merely intended to provide an overview of some of the problems of today's designs, and are not intended to be exhaustive. Other problems with the state of the art and corresponding benefits of the invention may become further apparent upon review of the following description of various non-limiting embodiments of the invention.

### SUMMARY

Motion estimation (ME) optimizations are provided for video encoding and compression processes that efficiently share data processing between host and graphics processing models. The optimizations take into account dependencies introduced by a corresponding encoding model, such as block level dependencies introduced by H.264/AVC. Arithmetic intensity is adjustable to the underlying graphics hardware for further optimization resulting in improved, real-time encoding of video data.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The motion estimation optimizations for video encoding processes in accordance with the invention are further described with reference to the accompanying drawings in which:

FIGS. 1A and 1B illustrate exemplary, non-limiting encoding processes performed in accordance with the optimizations of the invention;

FIG. 2 is a block diagram illustrating a representative co-processing model for optimized encoding in accordance with the invention;

FIG. 3 is a flow diagram illustrating exemplary aspects of a process for performing motion estimation for video encoding in accordance with the invention;

FIG. 4 is a block diagram representing various elements of a modern graphics pipeline that are employed in embodiments of the invention;

FIG. 5 is a flow diagram illustrating exemplary flow of data between a host and graphics subsystem in accordance with the optimizations for motion estimation for video encoding in accordance with the invention;

FIGS. 6A and 6B illustrate exemplary calculation of absolute differences for a representative set of reference positions and corresponding summing of vectors to obtain SAD values in accordance with encoding processes of the invention;

FIG. 7 is a bar graph showing results observed from implementation of the optimized video encoding processes of the invention with various arithmetic intensities;

FIG. 8 is another flow diagram illustrating exemplary aspects of a process for performing optimized motion estimation for video encoding in accordance with the invention;

FIG. 9 is a block diagram representing an exemplary non-limiting computing system or operating environment in which the present invention may be implemented; and

FIG. 10 illustrates an overview of a network environment suitable for service by embodiments of the invention.

### DETAILED DESCRIPTION

### Overview

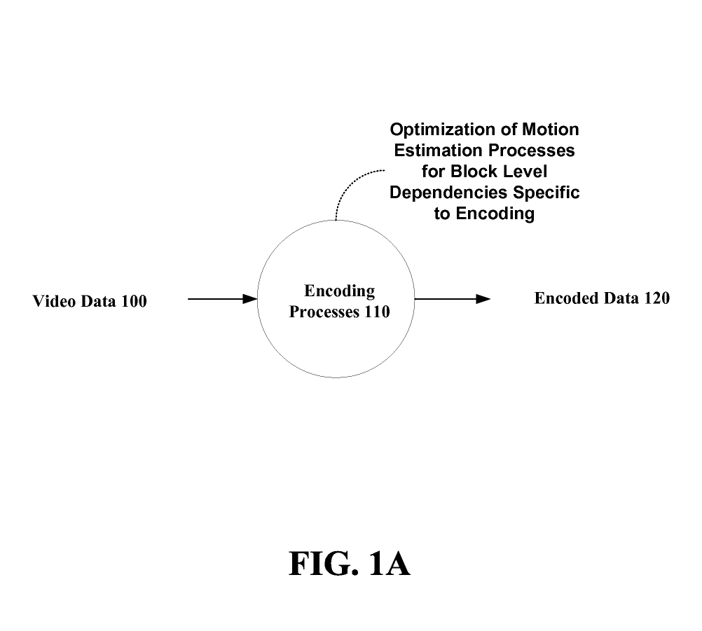

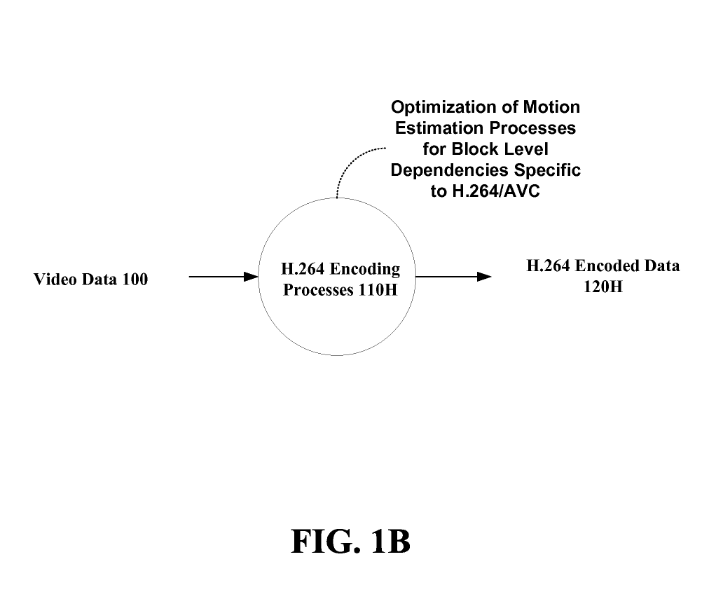

As discussed in the background, current systems that use a GPU module for shared processing for encoding video data are sub-optimal under circumstances involving encoding format-specific dependencies. The invention eliminates this problem by designing a co-processing model that optimizes motion estimation (ME) cost calculations based on block level dependencies introduced by encoding format. As shown in FIG. 1A, at a high level, video encoding includes receiving video data 100, encoding the video data 100 according to a set of encoding rules implemented by a set of encoding processes 110 that enable a corresponding decoder (not shown) to decode the encoded data 120 that results from encoding processes 110. Encoding processes 110 typically compress video data 100 such that representation 120 is more compact than representation 100. Encodings can introduce loss of resolution of the data while others are lossless allowing video data 100 to be restored to an identical copy of video data 100.

As shown by FIG. 1B, an example of an encoding format is H.264/AVC. To encode data in H.264/AVC format, video data 100 is processed by encoding processes 110H that implement H.264/AVC encoding processes, which results in encoded data 120H encoded according to the H.264/AVC format. With H.264/AVC, for instance, the motion vector (MV) predictor, which is the median MV of three neighboring coded blocks, is involved in the cost function for ME. In this respect, with H.264/AVC, the MV predictor affects the search center of ME.

As mentioned in the background, however, existing GPU based implementations of ME are not suitable for H.264/AVC because of the dependency introduced by the MV predictor that is ignored. In this regard, previous implementations assume no dependency among adjacent blocks, which is an assumption that does not hold for H.264/AVC. Previous implementations also perform unsatisfactorily because of their low arithmetic intensity, which is defined as operation per word transferred.

Accordingly, to address these deficiencies, as generally illustrated in the block diagram of FIG. 1B, the invention performs ME on a block-by-block basis for encodings, such as H.264/AVC, that introduce block level dependencies. In addition, arithmetic intensity can be adjusted to optimize the efficiency on different graphics cards having different characteristics. As a result of using the optimal encoding processes of the invention, H.264/AVC encoding processing is substantially faster than existing systems that implement SIMD optimized CPU processing, e.g., by a factor of 10 times or more.

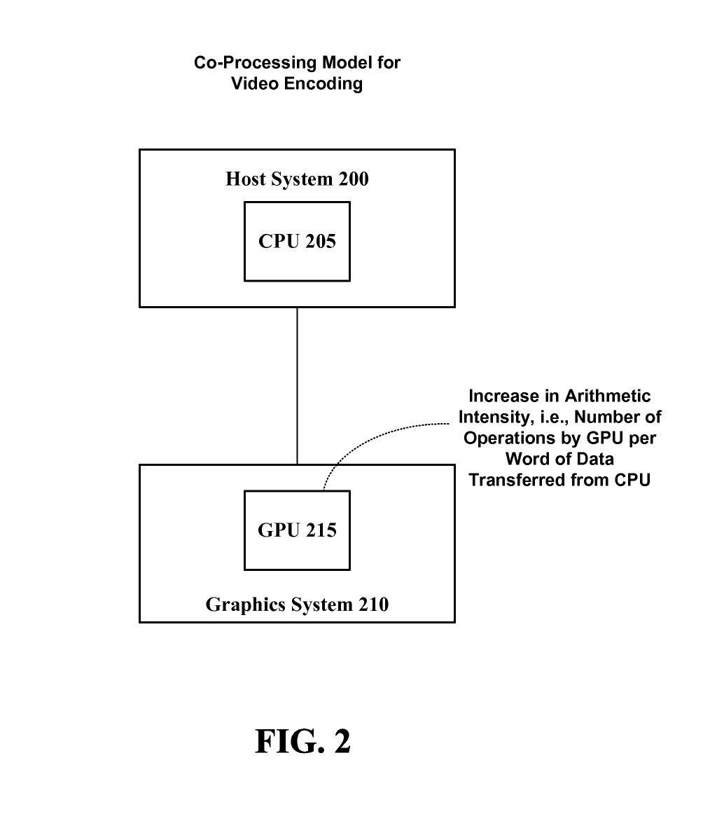

FIG. 2 is a block diagram illustrating an exemplary, non-limiting co-processing model for sharing processing for performing the optimized encoding in accordance with the invention. In a co-processing model, encoding processing is shared between a host processor, such as CPU 205 of host system 200, and a co-processor, such as GPU 215 of graphics system 210. As a result of the optimizations of the ME processes of the invention, the encoding time reduces significantly by efficiently utilizing the processing power of GPU 215. In addition, arithmetic intensity, i.e., the number of operations by GPU 215 per word of data transferred from texture memory, optimizes for different graphics system 210 easily.

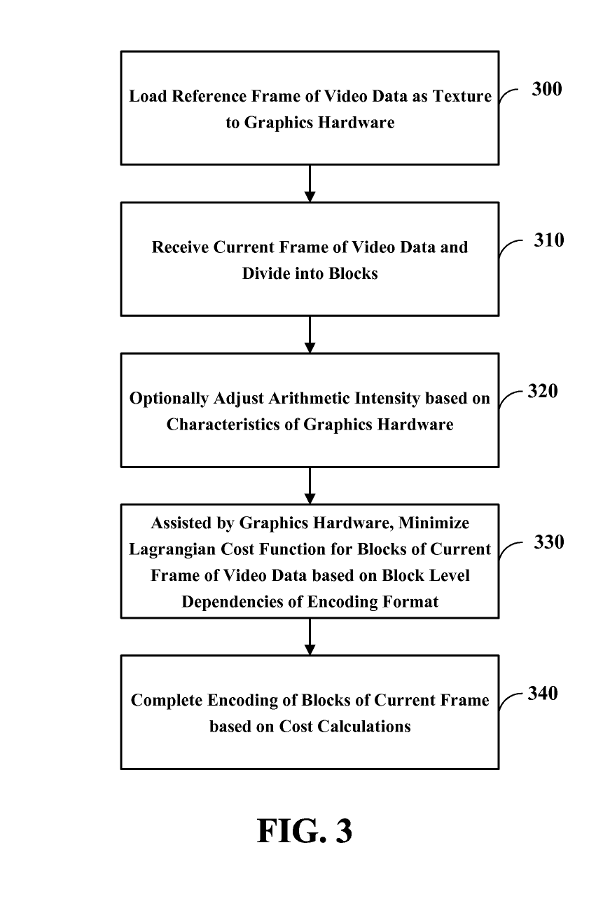

FIG. 3 is a flow diagram of a generalized process for performing optimal encoding in accordance with the invention. At 300, a reference frame of a sequence of video is loaded as a texture to graphics hardware. Next, at 310, a current frame of the video is divided into sub-blocks. Optionally, at 320, arithmetic intensity can be tuned to the characteristics of graphics hardware. At 330, assisted by the graphics hardware, the invention minimizes the Lagrangian cost function for the sub-blocks of the current frame based on block level dependencies defined by the encoding format, e.g., H.264/AVC. Then, at 340, the sub-blocks of the current frame are encoded based on the cost calculations. The process is repeated for subsequent frames of the video sequence.

As a roadmap for what follows, a brief overview of programmable graphics pipelines is given, and aspects of rate-constrained ME in H.264/AVC based on block level dependencies are set forth in more detail. Then, embodiments of the optimizations for ME for encoding in accordance with the invention are described including various non-limiting implementation details. Next, an evaluation of the performance of the invention is revealed that compares operation of the invention with an optimized Intel CPU encoder SIMD implementation. Lastly, various non-limiting operating devices and environments in which the invention may be practiced are described.

### Programmable Graphics Pipelines

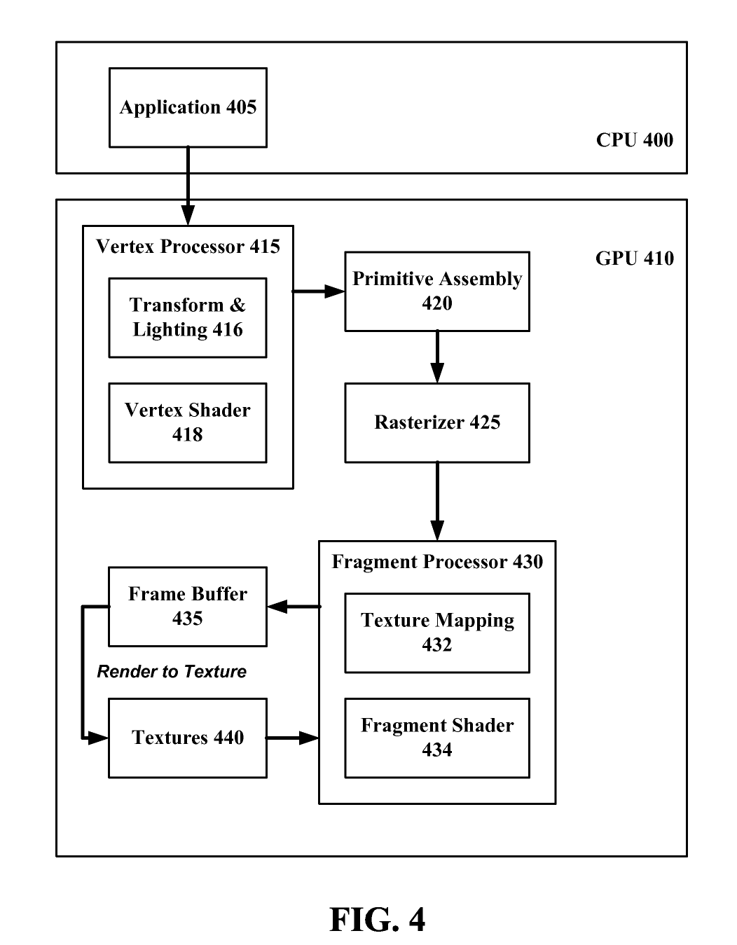

FIG. 4 generally illustrates a modern programmable graphics pipeline for sharing processing between a GPU 410 and a CPU 400. For instance, a typical scenario includes an application 405 that off-loads some degree of processing to a graphics subsystem including one or more GPUs 410.

Modern graphics hardware can implement several stages including transform and lighting (T&L) unit 416, primitive assembly unit 420, rasterizer 425, texture mapping unit 432 and frame buffer 435. A programmable vertex processor 415 and fragment processor 430 can also be included in modern graphics architectures. A set of customized operations are generally applied on a per-vertex and/or per-fragment basis by executing a program, called a vertex shader 418 or a fragment shader 434, on the programmable processors 415 and 430 as an alternative for the T&L unit 416 and texture mapping unit 432, respectively. Shaders 418 and 434 are designed with software much in the same way that other software is designed, e.g., via flexible shader programming languages. Together, for instance, the components can be assembled as a SIMD machine capable of performing operations on a vector with four (4) components. In graphics applications 405, sophisticated visual effects are generated with a series of shaders 418, 434 and multiple rendering passes to frame buffer 435 in communication with textures 440.

For general purpose computation, GPU 410 can be considered a stream processor that executes a number of kernels on data streams. As mentioned, application kernels can be written as a series of vertex shaders 418 or fragment shaders 434. Application-dependent data streams are stored as the geometries and textures 440. In one implementation of the ME module of the invention, kernels are used for cost calculation, merging and reduction. Textures 440 can be used to store reference frames and intermediate results for the GPU-based ME of the invention, further details of which are presented below.

### Rate Constrained Motion Estimation

As mentioned, in various non-limiting embodiments, the invention performs ME on a GPU for encoding formats, such as H.264/AVC, on a block-by-block basis. In a non-limiting example, first, a macroblock (MB) is divided into a set of sixteen 4×4 blocks. Then, for each 4×4 block, the cost for ME purposes is calculated. Next, the cost of each 4×4 block is summed by using multiple rendering passes. As mentioned, the arithmetic intensity can be adjusted in accordance with the invention by changing the number of 4×4 blocks being processed per rendering pass.

In more detail, H.264/AVC provides flexible MC and ME methodologies that support a combination of different block sizes ranging from 4×4 to 16×16 with separate MVs. Accordingly, besides the sum of absolute differences (SAD), the cost function for ME for H.264 is also a function of the MV predictor in order to estimate the bits required to code MVs, and hence introduces a dependency among adjacent blocks. The problem of choosing the best MV can thus be formulated as a rate-constrained optimization problem and the best MV is the one which minimizes the following Lagrangian cost function,

Jₘₒₜᵢₒₙ=D_{DFD}+λₘₒₜᵢₒₙRₘₒₜᵢₒₙ. Eqn. 1

Therefore, the ME in H.264/AVC can be written as

$${mv}^{*} = \text{arg} {min}_{{mv}^{i} ∈ s} {J}_{motion} . \qquad Eqn . 2$$

In the above equation, λₘₒₜᵢₒₙ is a Lagrangian multiplier imposing a rate constraint of motion information, which is quantization parameter (QP) dependent, and Rₘₒₜᵢₒₙ represents the bits required to code MVs. D_{DFD} can be either the SAD (a relatively simple distortion measure) or the sum of absolute difference of Hadamard-transformed coefficients (SATD) in H.264/AVC. The candidate MVⁱ, mv^{l} ∈ S that minimizes the cost Jₘₒₜᵢₒₙ is the best MV, mv*.

Hence, as shown in the Equation 1, Jₘₒₜᵢₒₙ is a function of D_{DFD}, λₑₘₒₜᵢₒₙ and Rₘₒₜᵢₒₙ, Rₘₒₜᵢₒₙ captures the dependency information among the adjacent blocks and depends on the difference between the current candidate MV and the MV predictor. Using the cost function of Equation 1, the invention provides GPU-based implementations that perform ME in a highly efficient manner for H.264/AVC. Furthermore, arithmetic intensity can be adjusted to better utilize the computing power of different graphics cards.

### GPU-Based Motion Estimation

As mentioned, the cost function for ME in H.264/AVC depends on the MV predictor, which is the median MV of three neighboring coded blocks. In various non-limiting embodiments, the invention implements ME for H.264/AVC using programmable graphics hardware that takes this block level dependency into account in a rate constrained optimization for ME calculations.

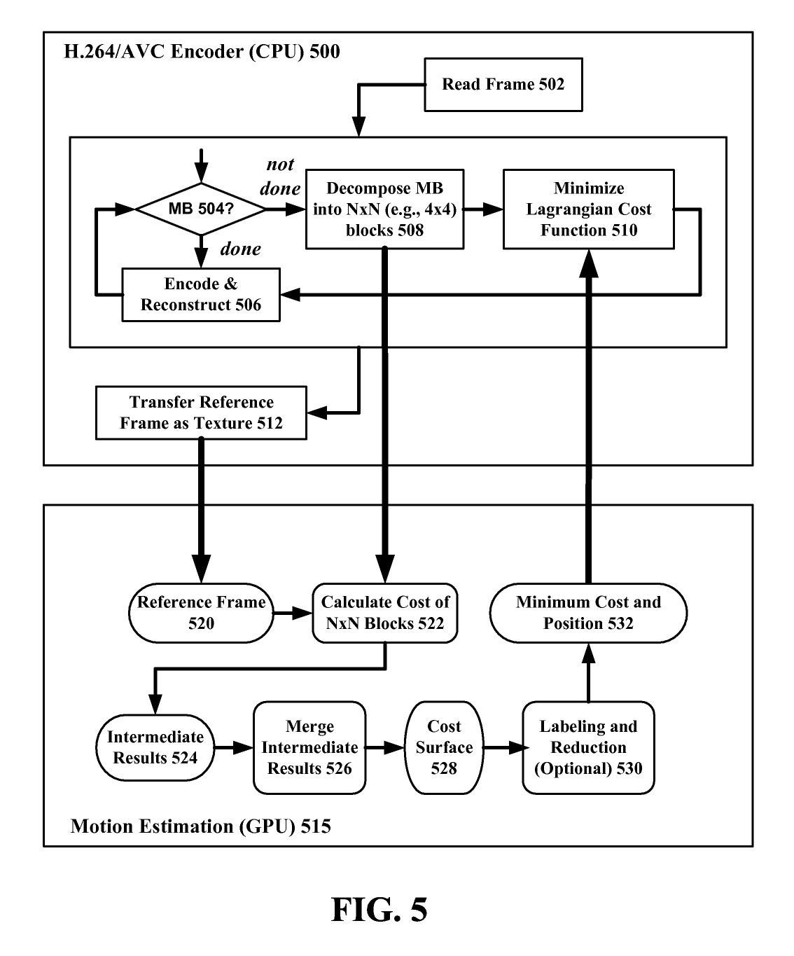

Optionally, where applicable, an exhaustive motion search can be implemented by the GPU, as opposed to other ME algorithms, because of its regular memory access pattern. Other ME algorithms can also be implemented, though an additional layer of texture would be introduced to specify the target searching position, resulting in a random memory access pattern and a dependent texture read. The repercussions of such random memory access pattern and dependent texture read are undesirable in modern graphics architecture. FIG. 5 illustrates an exemplary non-limiting data representation and corresponding dataflow for a GPU-based ME module that optimizes the cost function of Equation 1 taking into account block level dependencies in accordance with the invention.

As shown in FIG. 5, in accordance with the invention, current MBs and corresponding N×N subblocks are handled at 508, and reference frames 520 can be represented as texture objects and stored in the texture memory. However, bandwidth is expensive in the graphics hardware such that unnecessary texture access should be avoided. As the current MB participates in each cost calculation at different positions, the subblocks can optionally be passed as a uniform parameter instead of storing them as a texture object, advantageously eliminating a large number of texture operations.

In one non-limiting embodiment, sixteen 4×4 matrices, e.g., represented as float 4×4, are used to represent the values of the current MB and for passing the values into a fragment program implemented by GPU 515. Such representation takes advantage of data-level parallelism and matches the smallest partition size supported by H.264/AVC. Also, since reference frames are typically large, the fragment program will tend to access the reference frames repeatedly. It is thus desirable at 512 to load the reference frames once to the texture memory 520 before encoding the current frame, in order to avoid expensive duplicative transfers of reference frames from main memory to video memory.

Motion search area specifies a set of possible candidate MVs. To clip the search area at the frame boundary, CPU implementations typically perform boundary checking with an if-statement. However, limited branching support in modem GPUs implies an extra cost due to the execution of a branch in the fragment program. To avoid this issue, the search area can be determined by the CPU in accordance with the invention. Then, a quadrilateral can be drawn by the CPU that serves to represent the frame boundary to the graphics hardware. Then, the fragments inside the quadrilateral after projection are processed by the fragment program. Also, the actual position in the reference frame can be specified as texture coordinates. As a result, a branch-free fragment shader is achieved, which is advantageous particularly for GPUs with limited branching support.

As mentioned, FIG. 5 is a block diagram of a shader implementation of the invention and a corresponding dataflow for a H.264/AVC encoder CPU implementation 500 that offloads cost calculations to a GPU implementation 515 that optimizes motion estimation for an encoding format while taking into account block level dependencies. In more detail on the CPU side, at 502, a current frame is received by CPU 500. Then, for each MB of the frame at 504, the MB is decomposed in N×N blocks at 508, e.g., 4×4 blocks. Next, the Lagrangian cost function of Equation 1 is calculated at 510 as assisted by the output of optimized ME calculations performed by GPU 515. Once the MBs of the frame are processed according to the optimized cost function, the MBs are encoded accordingly, and the process repeats until all MBs of all frames are completed.

As shown, the system can be divided into three conceptual components. The first part is cost calculation for N×N blocks that compose a macroblock, e.g., 4×4 blocks. Following Equation 1, the cost for each of the 4×4 blocks is calculated at 522 and intermediate results 524 are loaded into texture memory. A blending function adds the motion cost and results from the fragment shader. To provide an optimal arithmetic intensity, the number of blocks processed by GPU at 522 needs to be optimized for the graphics hardware 515 per reference block transferred from texture memory. One or more blocks can be processed in a single cycle with one reference block loaded and the intermediate results 524 are stored in different rendering target. Then, the merging procedure 526 is used to combine the intermediate results 524 in different rendering targets and determine the final cost 528. Finally, the cost for the search area optionally undergoes a labeling and reduction process 530, returning the minimum cost and its corresponding position at 532. Prior to reduction, the labeling process 530 associates the cost with its corresponding position. Therefore, the result of reduction is a triple (SAD, refₓ, ref_{y}), where refₓ and ref_{y} are the coordinates of the reference position corresponding to the minimum cost. However, this is optional since, in some cases, extra rendering passes may be more expensive than data readback from GPU. See, e.g., Table I below for exemplary performance data with and without readback.

In one embodiment, the address calculation of the labeling process 530, such as the calculation of the position of reference block and intermediate result, can be performed by the vertex processor and the rasterization interpolates them for each fragment. The fragment processor can in turn perform cost calculation, thus distributing the workload of the graphics hardware 515 over the vertex processor and the fragment processor.

In one non-limiting aspect, implementation of the invention leads to data-level parallelism and efficient SAD computation using a GPU while simultaneously allowing arithmetic intensity to be tuned to graphics hardware deployed. As mentioned, arithmetic intensity is formally defined as operation per word transferred. With higher arithmetic intensity, more computation is performed for each word fetched from memory.

With respect to data-level parallelism, with the optimizations of the ME calculations of the invention, the current MB is decomposed, e.g., into sixteen 4×4 matrices as float 4×4, so that very fast matrix manipulation routines can be executed by the GPU. On the other hand, the reference frames are loaded into the texture memory once so that the fragment program can fetch the pixel values for calculation in an efficient manner. In one non-limiting embodiment, four luminance values are packed in a pixel with 8-bits per channel. Also, data packing can be implemented to take advantage of data-level parallelism and achieve better bandwidth utilization since more data can be fetched and processed at a time. However, ME processes access a chunk of values at any position whereas with such data packing, access is restricted to multiples of the fourth position.

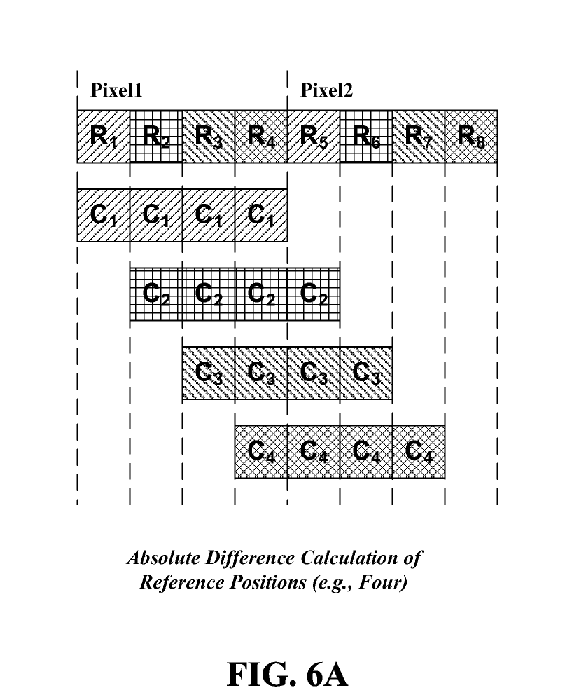

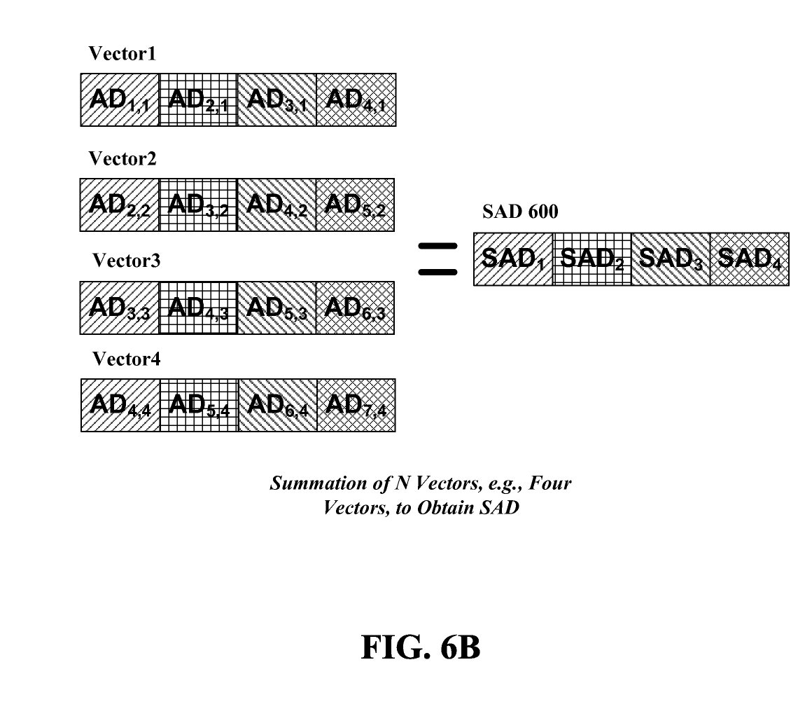

To address this issue, in one non-limiting embodiment, the fragment program fetches two adjacent pixels, e.g., eight luminance values, from the texture and performs calculation of four reference positions in a single pass. A simplified ID demonstration is illustrated in FIG. 6A showing an exemplary calculation of absolute difference calculations for four reference positions. Pixel 1 and 2 contain eight values in reference frame, Rᵢ, where i=1, 2, . . . , 8 and given the current block as C_{J} where j=1, 2, 3, 4. Using a swizzle operator, for instance, absolute difference are computed on each component of the current block against the reference frame as shown in FIG. 6A resulting in four vectors containing the absolute difference, ADi,j where i and j indicate the position corresponding to the reference frame and current block, respectively, i=1, 2, . . . , 8 and j=1, 2, 3, 4 in FIG. 6B.

FIG. 6B illustrates exemplary summation of vectors to obtain the SAD values in accordance with the invention and its data packing. For instance, the four SADs corresponding to reference positions R₁, R₂, R₃ and R₄ can be computed by summing the four vectors as shown in FIG. 6B, rendering the result to the frame buffer. Advantageously, the problem of restricted access is thereby avoided while providing a degree of parallelism.

One measurement for the performance of a GPU-based method, as compared to other methods, is the arithmetic intensity. The invention advantageously provides a mechanism to adjust the arithmetic intensity depending on the processing ability of hardware. In this regard, the arithmetic intensity can be adjusted by controlling the number of 4×4 blocks processed per rendering pass. Referring to FIG. 6A, for instance, besides C₁, C₂, C₃ and C₄, the absolute difference for C₅, C₆, C₇ and C₈ can be computed with Rᵢ and the results can be rendered to another rendering target. Hence, the number of operations by GPU doubled without extra texture loading operation.

Multiple rendering targets (MRTs), which allow multiple RGBA pixels output in each pass, can be used to handle the increase in output values. Then, in the merging step, the results are added together by offsetting the textures. As a result, more arithmetic operations are performed by the invention for a given number of texture operations. However, the increase in arithmetic intensity is bounded by the limited number of MRTs available in current graphics hardware, which currently is up to four, but is expected to increase along with other advancements in GPU technology.

The performance of the GPU-based implementation of the invention on both consumer-level (Nvidia GeForce 6600GT AGP) and high-end (Nvidia GeForce 7800GT PCIe) graphics cards was measured. Tests were also performed on a PC with an Intel Pentium 4 3.2 GHz processor and 1 GB DDR2 memory. Another PC with an Intel Pentium 4 1.8 GHz processor and 1GB RDRAM memory was also used as a reference point. As measured, the performance of GPU implementations of the invention, the impact on limited download bandwidth and the performance change by adjusting the arithmetic intensity demonstrate the significant improvements enabled by the invention.

Defining execution time as the user time measured from the beginning to the end of ME, the speed of the P4-3.2 GHz implementation was observed to be constantly about two times faster than the P4-1.8 GHz in different resolutions and search ranges. However, the speed of the proposed GPU implementation with data readback shows ten times and five times faster than the CPU implementation on P4-1.8 GHz and P4-3.2 GHz, respectively. The speed observably increases with the search range because a larger search range diminishes the effect of setup overhead by the graphics API interfacing between the host and graphics hardware.

To study how the download bandwidth (GPU to CPU) may affect the overall performance, the same set of measurements were recorded without readback of the data from GPU to CPU. As a result, the speed was observed to double as compared to measurements made with the data readback in both graphics cards tested. While PCIe is expected to provide higher readback bandwidth than AGP, they exhibit similar readback bandwidth of float texture in RGBA format (around 500 MB/sec measured by a tool called GPUbench), which is the main bottleneck in most general purpose computation performed by a GPU which reads the data for further processing.

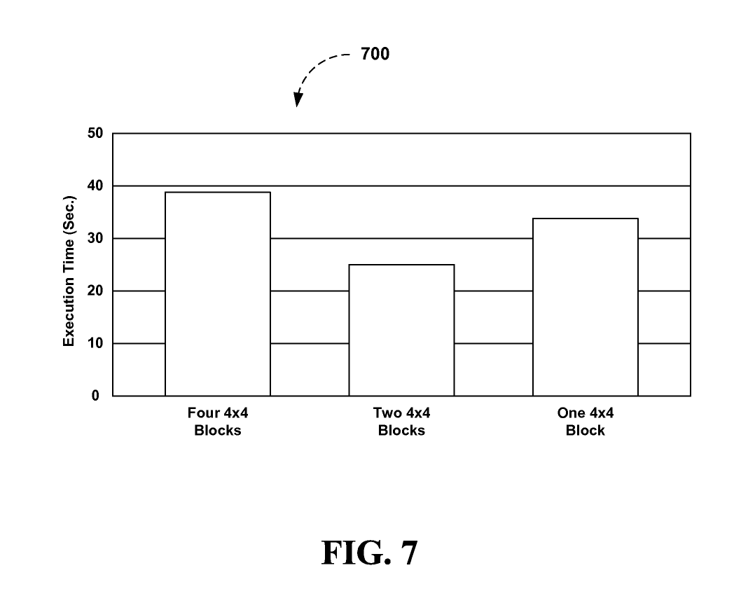

In addition, as mentioned, arithmetic intensity can be adjusted using the invention. By increasing the number of 4×4 blocks processed in a single pass, the average execution time can vary as illustrated by the bar graph 700 of FIG. 7. As illustrated, the best performance of the tested graphics hardware was achieved when two 4×4 blocks were processed in a single pass with two rendering targets, achieving an arithmetic intensity of about 10:1. If the number of 4×4 blocks processed in a single pass is further increased, the speed starts to decrease since the GPU becomes overloaded. The GPU implementation of the invention thus allows performance optimization by adjusting the arithmetic intensity to suit the graphics hardware.

Table I below represents a normalized comparison of the relative performance of various implementations of the invention, exhibiting average execution time in milliseconds (ms) for processing one frame.

TABLE I
Comparison of Execution Times of Different ME Methods

| | P4 | P4 | GF6600GT | GF7800GT | GF6600GT | GF7800GT |
|---|---|---|---|---|---|---|
| | 1.8 Ghz | 3.2 Ghz | with | with | without | without |
| | SIMD | SIMD | Readback | Readback | Readback | Readback |
| 1080 p ± 256 | 256197 | 142196 | 42962 | 25428 | 29050 | 12156 |
| 1080 p ± 128 | 71331 | 39146 | 13706 | 7975 | 8768 | 3706 |
| 1080 p ± 64 | 19909 | 10359 | 4800 | 2996 | 2756 | 1603 |
| 720 p ± 256 | 33684 | 15787 | 5271 | 3215 | 3509 | 1593 |
| 720 p ± 128 | 11268 | 5184 | 2025 | 1290 | 1275 | 665 |
| 720 p ± 64 | 3134 | 1481 | 778 | 615 | 459 | 396 |
| 720 p ± 32 | 847 | 400 | 378 | 343 | 247 | 359 |

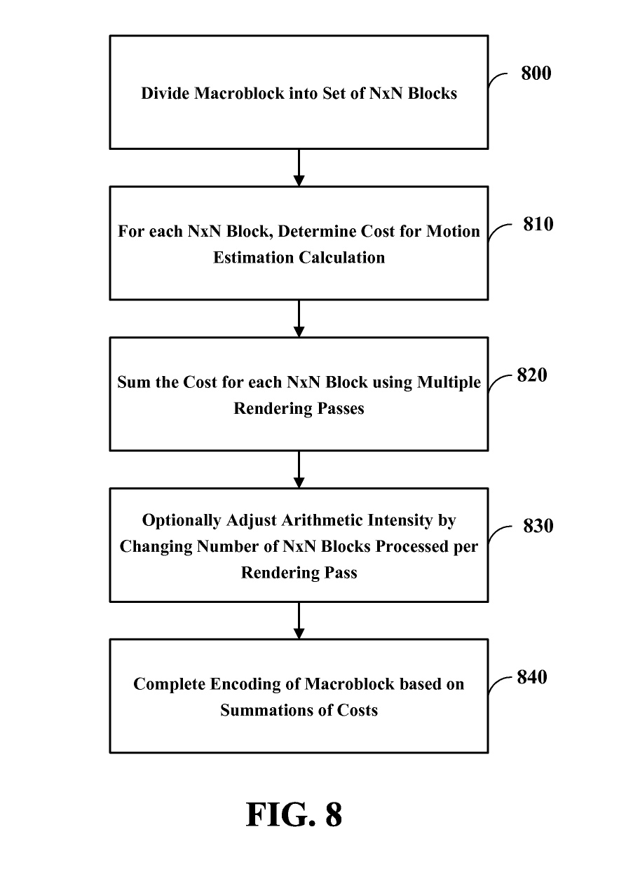

In various non-limiting embodiments described above, the invention performs ME on a GPU for encoding formats, such as H.264/AVC, on a block-by-block basis taking advantage of block level dependencies to optimize the ME processes. As described in connection with FIG. 8, first at 800, a macroblock (MB) is divided into a set of N×N blocks, e.g., sixteen 4×4 blocks, eight 8×8 blocks, or other subdivision depending on available graphics hardware. Then, at 810, for each N×N block, the cost for ME purposes is calculated. At 820, the cost of each N×N block is summed by using multiple rendering passes and with reference to a reference frame. The arithmetic intensity can be adjusted in accordance with the invention by changing the number of N×N blocks being processed per rendering pass at 830. Such adjustability, while optional, is particularly useful when the optimized encoding is applied to different GPUs. Where GPU characteristics are known in advance, the invention can be optimized for such characteristics as explained in more detail below. Lastly, the optimal encoding for the MB is carried out at 840 based on the cost calculations.

A GPU-based ME implementation in accordance with the invention thus offload computational burden from the CPU to the GPU in a way that is optimal for the latest H.264/AVC video coding standard. The invention can include a way to adjust the arithmetic intensity to maximize the performance of the ME optimizations on different GPUs. The invention thus clearly outperforms algorithms based on CPU processing alone, achieving on average about a ten times increase in speed. Download bandwidth appears to be a currently limiting factor to speed, but download bandwidth is expected to improve along with the increasing bandwidth of PCIe type buses.

### Exemplary Computer Networks and Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with optimization algorithms and processes performed in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the optimization algorithms and processes of the invention.

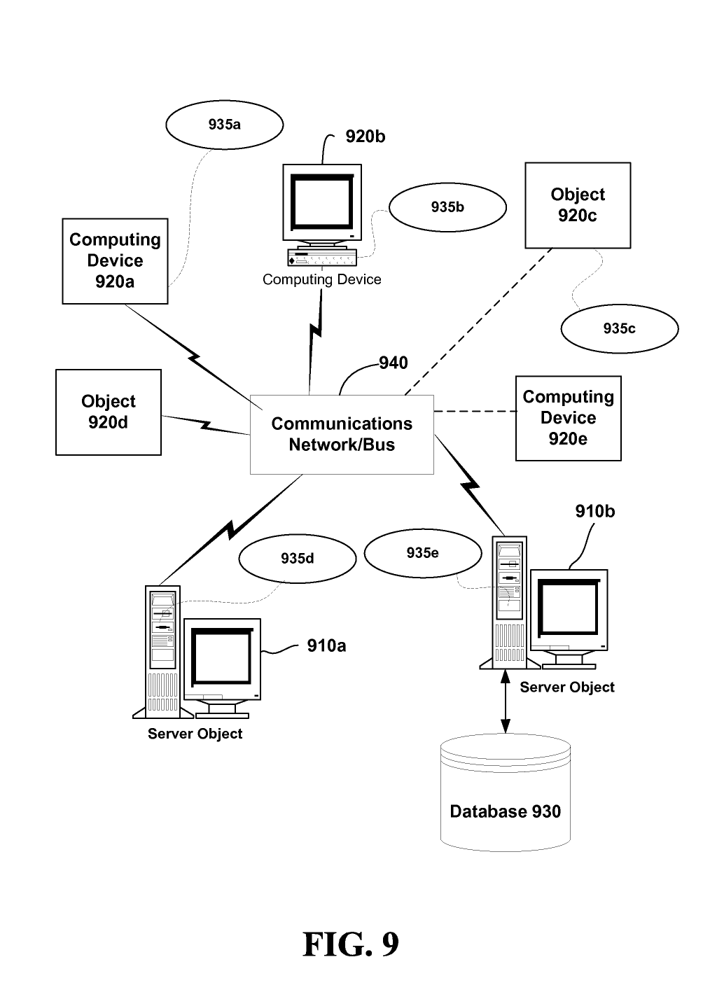

FIG. 9 provides a schematic diagram of an exemplary networked or distributed computing environment. The distributed computing environment comprises computing objects 910a, 910b, etc. and computing objects or devices 920a, 920b, 920c, 920d, 920e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 940. This network may itself comprise other computing objects and computing devices that provide services to the system of FIG. 9, and may itself represent multiple interconnected networks. In accordance with an aspect of the invention, each object 910a, 910b, etc. or 920a, 920b, 920c, 920d, 920e, etc. may contain an application that might make use of an API, or other object, software, firmware and/or hardware, suitable for use with the design framework in accordance with the invention.

It can also be appreciated that an object, such as 920c, may be hosted on another computing device 910a, 910b, etc. or 920a, 920b, 920c, 920d, 920e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to optimization algorithms and processes according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11A/B/G) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 9, as an example, computers 920a, 920b, 920c, 920d, 920e, etc. can be thought of as clients and computers 910a, 910b, etc. can be thought of as servers where servers 910a, 910b, etc. maintain the data that is then replicated to client computers 920a, 920b, 920c, 920d, 920e, etc., although any computer can be considered a client, a server, or both, depending on the circumstances. Any of these computing devices may be processing data or requesting services or tasks that may implicate the optimization algorithms and processes in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the optimization algorithms and processes of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 9 illustrates an exemplary networked or distributed environment, with server(s) in communication with client computer (s) via a network/bus, in which the present invention may be employed. In more detail, a number of servers 910a, 910b, etc. are interconnected via a communications network/bus 940, which may be a LAN, WAN, intranet, GSM network, the Internet, etc., with a number of client or remote computing devices 920a, 920b, 920c, 920d, 920e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to communicate data over a network.

In a network environment in which the communications network/bus 940 is the Internet, for example, the servers 910a, 910b, etc. can be Web servers with which the clients 920a, 920b, 920c, 920d, 920e, etc. communicate via any of a number of known protocols such as HTTP. Servers 910a, 910b, etc. may also serve as clients 920a, 920b, 920c, 920d, 920e, etc., as may be characteristic of a distributed computing environment.

As mentioned, communications may be wired or wireless, or a combination, where appropriate. Client devices 920a, 920b, 920c, 920d, 920e, etc. may or may not communicate via communications network/bus 14, and may have independent communications associated therewith. For example, in the case of a TV or VCR, there may or may not be a networked aspect to the control thereof Each client computer 920a, 920b, 920c, 920d, 920e, etc. and server computer 910a, 910b, etc. may be equipped with various application program modules or objects 935a, 935b, 935c, etc. and with connections or access to various types of storage elements or objects, across which files or data streams may be stored or to which portion(s) of files or data streams may be downloaded, transmitted or migrated. Any one or more of computers 910a, 910b, 920a, 920b, 920c, 920d, 920e, etc. may be responsible for the maintenance and updating of a database 930 or other storage element, such as a database or memory 930 for storing data processed or saved according to the invention. Thus, the present invention can be utilized in a computer network environment having client computers 920a, 920b, 920c, 920d, 920e, etc. that can access and interact with a computer network/bus 940 and server computers 910a, 910b, etc. that may interact with client computers 920a, 920b, 920c, 920d, 920e, etc. and other like devices, and databases 930.

### Exemplary Computing Device

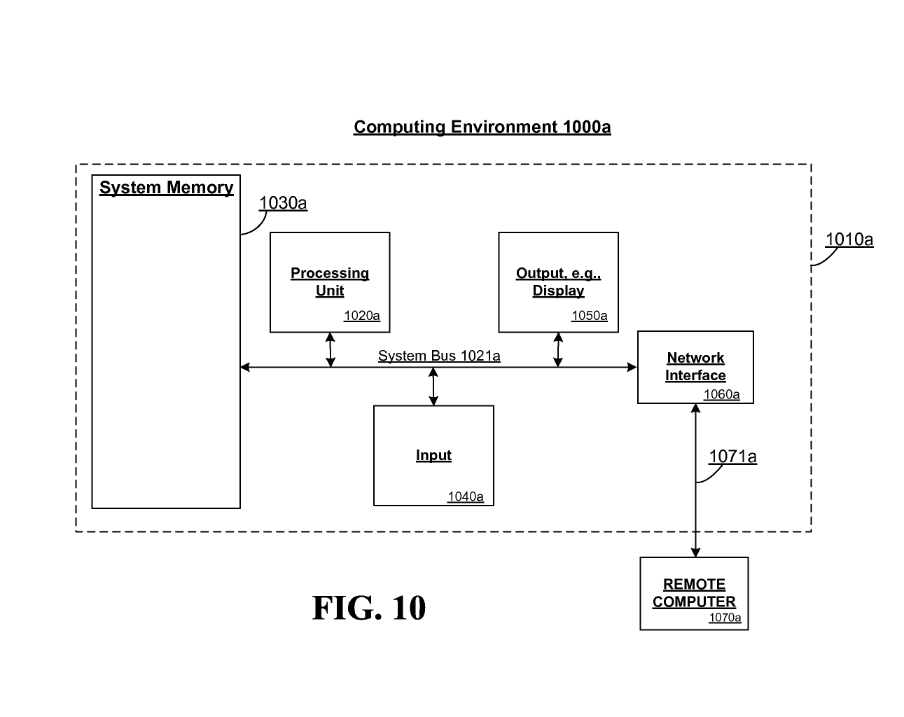

As mentioned, the invention applies to any device wherein it may be desirable to communicate data, e.g., to a mobile device. It should be understood, therefore, that handheld, portable and other computing devices and computing objects of all kinds are contemplated for use in connection with the present invention, i.e., anywhere that a device may communicate data or otherwise receive, process or store data. Accordingly, the below general purpose remote computer described below in FIG. 10 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer executable instructions, such as program modules, being executed by one or more computers, such as client workstations, servers or other devices. Those skilled in the art will appreciate that the invention may be practiced with other computer system configurations and protocols.

FIG. 10 thus illustrates an example of a suitable computing system environment 1000a in which the invention may be implemented, although as made clear above, the computing system environment 1000a is only one example of a suitable computing environment for a media device and is not intended to suggest any limitation as to the scope of use or functionality of the invention. Neither should the computing environment 1000a be interpreted as having any dependency or requirement relating to any one or combination of components illustrated in the exemplary operating environment 1000a.

With reference to FIG. 10, an exemplary remote device for implementing the invention includes a general purpose computing device in the form of a computer 1010a. Components of computer 1010a may include, but are not limited to, a processing unit 1020a, a system memory 1030a, and a system bus 1021a that couples various system components including the system memory to the processing unit 1020a. The system bus 1021a may be any of several types of bus structures including a memory bus or memory controller, a peripheral bus, and a local bus using any of a variety of bus architectures.

Computer 1010a typically includes a variety of computer readable media. Computer readable media can be any available media that can be accessed by computer 1010a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1010a. Communication media typically embodies computer readable instructions, data structures, program modules or other data in a modulated data signal such as a carrier wave or other transport mechanism and includes any information delivery media.

The system memory 1030a may include computer storage media in the form of volatile and/or nonvolatile memory such as read only memory (ROM) and/or random access memory (RAM). A basic input/output system (BIOS), containing the basic routines that help to transfer information between elements within computer 1010a, such as during start-up, may be stored in memory 1030a. Memory 1030a typically also contains data and/or program modules that are immediately accessible to and/or presently being operated on by processing unit 1020a. By way of example, and not limitation, memory 1030a may also include an operating system, application programs, other program modules, and program data.

The computer 1010a may also include other removable/non-removable, volatile/nonvolatile computer storage media. For example, computer 1010a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1021a through a non-removable memory interface such as an interface, and a magnetic disk drive or optical disk drive is typically connected to the system bus 1021a by a removable memory interface, such as an interface.

A user may enter commands and information into the computer 1010a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1020a through user input 1040a and associated interface(s) that are coupled to the system bus 1021a, but may be connected by other interface and bus structures, such as a parallel port, game port or a universal serial bus (USB). A graphics subsystem may also be connected to the system bus 1021a. A monitor or other type of display device is also connected to the system bus 1021a via an interface, such as output interface 1050a, which may in turn communicate with video memory. In addition to a monitor, computers may also include other peripheral output devices such as speakers and a printer, which may be connected through output interface 1050a.

The computer 1010a may operate in a networked or distributed environment using logical connections to one or more other remote computers, such as remote computer 1070a, which may in turn have media capabilities different from device 1010a. The remote computer 1070a may be a personal computer, a server, a router, a network PC, a peer device or other common network node, or any other remote media consumption or transmission device, and may include any or all of the elements described above relative to the computer 1010a. The logical connections depicted in FIG. 10 include a network 1071a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1010a is connected to the LAN 1071a through a network interface or adapter. When used in a WAN networking environment, the computer 1010a typically includes a communications component, such as a modem, or other means for establishing communications over the WAN, such as the Internet. A communications component, such as a modem, which may be internal or external, may be connected to the system bus 1021a via the user input interface of input 1040a, or other appropriate mechanism. In a networked environment, program modules depicted relative to the computer 1010a, or portions thereof, may be stored in a remote memory storage device. It will be appreciated that the network connections shown and described are exemplary and other means of establishing a communications link between the computers may be used.

While the present invention has been described in connection with the preferred embodiments of the various Figures, it is to be understood that other similar embodiments may be used or modifications and additions may be made to the described embodiment for performing the same function of the present invention without deviating therefrom. For example, one skilled in the art will recognize that the present invention as described in the present application may apply to any environment, whether wired or wireless, and may be applied to any number of such devices connected via a communications network and interacting across the network. Therefore, the present invention should not be limited to any single embodiment, but rather should be construed in breadth and scope in accordance with the appended claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g. compact disk (CD), digital versatile disk (DVD) . . . ), smart cards, and flash memory devices (e.g. card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the various flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom.

While exemplary embodiments refer to utilizing the present invention in the context of particular programming language constructs, specifications or standards, the invention is not so limited, but rather may be implemented in any language to perform the optimization algorithms and processes. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for encoding video data including a sequence of image frames in a computing system, comprising:
transmitting at least one reference frame of the sequence of image frames to graphics hardware;
identifying a set of blocks within a current frame of the sequence to be encoded;
transmitting each block of the set of blocks to graphics hardware for a motion estimation cost calculation based on the at least one reference frame that takes into account dependencies of data represented by the set of blocks;
receiving the motion estimation cost calculations for each block from the graphics hardware; and
encoding the set of blocks based on the motion estimation cost calculations received from the graphics hardware.

2. The method of claim 1, wherein the encoding includes encoding the set of blocks according to the applicable video coding standard based on motion estimation cost calculations that take into dependencies of nearby blocks.

3. The method of claim 1, further including:
adjusting an arithmetic intensity of the graphics hardware performing the motion estimation cost calculations including adjusting a number of blocks from the set of blocks processed per rendering pass by the graphics hardware.

4. The method of claim 1, wherein the transmitting includes transmitting the at least one reference frame to memory of the graphics hardware as at least one texture object.

5. The method of claim 1, wherein the identifying includes identifying a set of blocks, in any dimension, for the current frame.

6. The method of claim 5, wherein the identifying includes dividing each block of the set of blocks, in any dimension, into N×N sub blocks of pixel data, where N is an integer power of 2.

7. The method of claim 6, wherein the dividing includes sub-dividing each block into smaller blocks of pixel data in accordance with a size of a data type supported by the graphics hardware.

8. The method of claim 1, further comprising:
receiving a next frame after the current frame in the sequence of image frames and performing at least the identifying, transmitting, receiving and encoding steps for the next frame.

9. A computer readable medium comprising computer executable instructions for performing the method of claim 1.

10. A method for encoding video data including a sequence of image frames by a computing system using a co-processing model including host system having one or more central processing units (CPUs) and a graphics system including one or more graphics processing units (GPUs), comprising:
receiving one or more reference frames of the sequence of image frames from the host system and storing the one or more reference frames in texture memory;
receiving a current block of a set of blocks identified in a current frame of the sequence to be encoded;
based on the one or more reference frames, determining by the graphics system a motion estimation cost for the current block based on values previously computed and temporarily stored by the graphics system for at least one block of the set of blocks nearby to the current block; and
transmitting the motion estimation cost for the current block to the host system for encoding of the current block based on the motion estimation cost.

11. The method of claim 10, wherein the determining includes determining the motion estimation cost for the current block for encoding the set of blocks according to the video coding standard based on values previously computed and stored for at least one adjacent block to the current block.

12. The method of claim 10, wherein the determining includes determining motion estimation cost for the current block based on one or more rendering passes over the data of the current block.

13. The method of claim 10, further including:
optimizing an arithmetic intensity measure of the GPU by adjusting a number of blocks processed per rendering pass by the GPU.

14. The method of claim 10, wherein the determining of the motion estimation cost for the current block includes determining a parameter that depends on a parameter of a set of blocks adjacent to the current block.

15. The method of claim 10, wherein the determining of the motion estimation cost for the current block includes:
receiving by the graphics system at least one specialized shader including at least one vertex shader, at least one fragment shader, or both; and
executing the at least one specialized shader with respect to the current block to determine the motion estimation cost.

16. The method of claim 10, further comprising:
storing the values for the at least one block of the set of blocks nearby to the current block in texture memory.

17. The method of claim 10, wherein the determining of the motion estimation cost for the current block includes computing a sum of absolute differences (SAD) of pixel values.

18. The method of claim 17, wherein the determining of the motion estimation cost for the current block includes computing a value to choose the best block based on at least one predetermined criterion.

19. Graphics processing apparatus comprising means for performing the method of claim 10.

20. A video compression system for compressing video in a computing system, comprising:
at least one data store for storing a plurality of frames of video data;
a host system that offloads processing for part of an encoding process for the plurality of frames to a graphics subsystem by transmitting, to the graphics subsystem, a reference frame of the plurality of frames and a set of blocks identified in a current frame for a motion estimation cost calculation; and
a graphics subsystem that performs one or more rendering passes over each block of the set of blocks to compute a motion estimation cost for each block received from the host system, where the motion estimation cost computation for a block is based on the reference frame and intermediate results stored for blocks nearby to the block,
wherein the host system performs the encoding process for each block based on the motion estimation cost for the block returned by the graphics subsystem.

21. The system of claim 20, wherein the host system performs the encoding process according to the applicable video coding standard used.

22. The system of claim 20, wherein a number of operations performed by the graphics subsystem per word transferred by the host system is adjusted by changing a number of blocks from the set of blocks processed per rendering pass by the graphics subsystem.

23. The system of claim 20, wherein the graphics subsystem stores intermediate results for nearby blocks in texture memory of the graphics subsystem.
